(19) United States
(12) Patent Application Publication
(10) Pub. No.: US 2005/0065311 A1
(43) Pub. Date: Mar. 24, 2005

(54) Articles derived from polymeric blends

(76) Inventor: Purushottam Das Agrawal, Akron, OH (US)

Correspondence Address: WALKER & JOCKE, L.P.A., 231 SOUTH BROADWAY STREET, MEDINA, OH, 44256, US

(21) Appl. No.: 10/668,980

(22) Filed: Sep. 22, 2003

(51) Int. Cl. C08L 53/00

(52) U.S. Cl. 528/88

(57) ABSTRACT

This invention relates to articles of manufacture having ultra-violet stability and a high coefficient of friction derived from a polymeric blend comprising thermoplastic polyurethanes (TPU) or polyvinyl chloride, a styrene-isoprene block copolymer, a maleic anhydride-ethylene copolymer, an ethylene-vinyl acetate copolymer, a phenolic resin, and a color reagent. These polymeric blends are capable of being bonded to a substrate, without the use of a tie layer, to prepare articles including slip-resistant walkways, and various sizes of tubing or hoses useful in various systems such as fuel systems.

### FIELD OF THE INVENTION

This invention relates to polymeric compositions, and to the process for preparing same and more specifically to articles of manufacture derived from polymeric blends. The polymeric blends of this invention have ultra-violet stability and a high coefficient of friction and therefore are particularly useful in the preparation of slip resistant surface coverings to enhance safety on flat, sloped or vertical surfaces. These polymeric blends can be bonded to flexible substrates and used in preparing various anti-slip or walkway products. In addition, these polymeric blends can be bonded to a particular substrate, e.g. nylon and used in the preparation of flexible hoses or tubes for use in fuel systems.

### BACKGROUND OF THE INVENTION

Commercial products are available for application to a variety of surfaces in order to decrease the slippery nature or to increase the frictional resistance of the surface. Such “slip resistant” articles typically comprise a backing wherein one surface of the backing is textured by friction particles. The other surface of the backing is coated with adhesive for direct application.

While there are numerous slip-resistant polymeric materials disclosed in the prior art, none of these materials, however, are particularly useful in the preparation of roof walkways. The polymeric blends of this invention can be specifically formulated and bonded to flexible substrates to form slip-resistant walkways and hoses or tubes for fuels. Generally hoses used in fuel systems have multi-ply structures consisting of various rubber and resin layers. These multi-ply fuel hoses, e.g. two-ply fuel hoses consist of a tubular inner ply and a thermoplastic resin or rubber outer ply laminated onto the peripheral surface of the tubular inner ply. In accordance with this invention, the multi-layer tubing or hoses can be co-extruded wherein the inner layer, i.e. the barrier layer is not permeable to hydrocarbons or other components of fuel.

### SUMMARY OF THE INVENTION

This invention relates to polymeric blends useful in the preparation of various articles including slip-resistant walkways, tubing or hoses for fuel systems, and coating for various fabrics such as nylon. More specifically, the articles of manufacture of this invention have ultra-violet stability and a high co-efficient of friction. These articles are derived from a polymeric blend comprising from about 30 to 60 parts by weight of a polymer selected from the group consisting of thermoplastic polyurethanes and polyvinyl chloride, 20 to 60 parts by weight of a styrene-isoprene-styrene block co-polymer, 0.0 to 2.0 parts by weight of a phenolic resin, 0.0 to 5.0 parts by weight of color reagent, 0.0 to 20 parts by weight of maleic anhydride-ethylene co-polymer, and 0.0 to 30 parts by weight of an ethylene-vinyl acetate copolymer. These polymeric blends can be bonded, e.g. extruded or molded, without a tie layer, onto various substrates e.g. polypropylene, polyvinyl chloride or nylon and used to prepare slip-resistant walkways, tubing or hoses for fuels and coatings for various synthetic fabrics such as nylon.

Accordingly, it is an object of this invention to provide novel polymeric blends useful in the preparation of specific articles.

It is another object of this invention to provide polymeric blends having a high coefficient of friction useful for the preparation of slip-resistant walkways.

It is another object of this invention to provide polymeric blends bonded to a flexible substrate useful for the preparation of hoses or tubing for fuel systems.

It is a further object of this invention to provide polymeric blends capable of being bonded to substrates without the need of a tie layer.

It is still a further object to provide polymeric blends and the process of bonding the blend to substrates by injection molding or extrusion without the need of a tie layer.

These and other objects will become apparent from a further and more detailed disclosure of the invention.

### DETAILED DESCRIPTION OF THE INVENTION

This invention relates to articles of manufacture including slip-resistant materials such as sheeting or walkways, tubes or hoses for fuel systems and coatings for synthetic fabrics such as nylon. The articles are characterized as having ultra-violet stability and a high coefficient of friction and are derived from a polymeric blend of polymers comprising from about 30 to 60 and preferably 40 to 50 parts by weight of a polymer selected from the group consisting of thermoplastic polyurethanes (TPU), and polyvinyl chloride, 20 to 60 and preferably 40 to 60 parts by weight of a styrene-isoprene-styrene copolymer, 0.0 to 2.0 and preferably 0.5 to 1.0 part by weight of a phenolic resin such as phenol formaldehyde, 0.0 to 5 parts by weight of a color reagent, 0.0 to 20 and preferably 1 to 15 or 5 to 10 parts by weight of a maleic anhydride-ethylene copolymer, and 0 to 30 and preferably 15 to 25 parts by weight of an ethylene-vinyl acetate copolymer.

In preparing the polymeric blends, the preferred polyurethanes of this invention are available as polyether-based thermoplastic polyurethanes obtained from the Noveon Chemical Co. under the trademark ESTANE. These polyurethanes have the properties shown in Table 1.

TABLE 1

| | | |
|---|---|---|
| PROCESSING | Extrusion | Temperature 185-195° C. |
| | Injection Molding | Temperature 175-185° C. |

| MECHANICAL | | | |
|---|---|---|---|
| PROPERTIES | TEST METHOD | UNIT | VALUE* |
| Hardness | DIN 53505 | shore A/D | 88/. |
| Density | DIN 53479 | g/cm³ | 1.24 |
| Tensile strength | DIN 53504 | MPa | 31 |
| Elongation | | % | 655 |
| Tensile Stress at | | | |
| 50% Elongation | | MPa | 4.9 |
| 100% Elongation | | MPa | 5.5 |
| 300% Elongation | | MPa | 7.2 |
| Tear Resistance | DIN 53515 | kN/m | 45 |
| Abrasion loss | DIN 53516 | mm3 | 150 |
| Rebound resilience | DIN 53512 | % | 35 |
| Brittle Point | DIN 53546 | ° C. | −70 |
| Oxygen Index | ASTM D26603 | % | 30 |
| Vertical burn test | UL 94 | | V0 |

Other thermoplastic polyurethanes (TPU) suited for use in the blends of the present invention are commercially available; see, Rubber Technology, 2^{nd} edition, edited by Maurice Morton (1973), Chapter 17, Urethane Elastomers. Thermoplastic polyurethanes (TPU) are derived from the reaction of polyester or polyether polyols with diisocyanates and also from the reaction of components with chain-extending agents such as low molecular weight polyols, preferably diols, or with diamines to form urea linkages. Thermoplastic polyurethanes are generally composed of soft segments, for example polyether or polyester polyols, and hard segments, usually derived from the reaction of the low molecular weight diols and diisocyanates. While a thermoplastic polyurethane with no hard segments can be used, those most useful will contain both soft and hard segments.

The processes for making TPU are well known and include single or multiple step polymerizations. In a single step polymerization, the diisocyanate, polyol and chain extending agent are combined and reacted, whereas in a multiple step process the polyol is first reacted with the diisocyanate to product a prepolymer which is subsequently reacted with the chain extender to build molecular weight. These processes are disclosed, for example, in U.S. Pat. Nos. 4,202,957 and 4,665,126. TPUs are also commercially available, from B.F. Goodrich Company under the trademark ESTANE, and from Dow Chemical under the trademark PELLETHANE.

The styrene-olefinic block copolymers of the polymeric blend are available from The Dow Chemical Co. as VECTOR 4111. VECTOR 4111 is a linear, pure SIS triblock copolymer with narrow molecular weight distribution. The polymer is a low styrene, low modulus copolymer. It contained <1% diblock. It is the softest pure SIS triblock and has the highest elasticity. The polymer has outstanding melt processability and is designed for use in elastomeric films or sheets and is a highly elastomeric compound. VECTOR 4114 (diblock isoprene-styrene-isoprene-styrene) is a highly elastomeric polymer having a hardness of 25 that will provide a softer composition and can be substituted for VECTOR 4111. Further, a blend of VECTOR 4111 and 4114 will also provide an elastomeric compound. The properties of VECTOR 4111 are shown in Table 2.

TABLE 2

| Properties | Test Method | Unit | Typical Value |
|---|---|---|---|
| Resin Properties | | | |
| Styrene | Dexco Method | Wt. % | 18 |
| Diblock Content | Dexco Method | Wt. % | <1.0 |
| MFR⁽¹⁾ | ASTM D 1238 | G/10 min | 12 |
| Ash | ASTM D 1416 | Wt. % | 0.3 |
| Physical Properties | | | |
| Tensile Strength⁽²⁾ | ASTM D 412 | PSI | 4000 |
| 300% Modulus⁽²⁾ | ASTM D 412 | PSI | 275 |
| Elongation⁽²⁾ | ASTM D 412 | % | 1200 |
| Hardness⁽³⁾ | ASTM D 2250 | Shore A | 39 |
| Specific Gravity | ASTM D 792 | g/ee | 0.93 |
| Product Form | | | Dense Pellet |

⁽¹⁾Condition (200° C./5 kg)
⁽²⁾Typical values on compressions molded plaques, intended only as guides and should not be construed as specifications.
⁽³⁾1 sec. Dwell.

The phenolic resins of the polymeric blend can be obtained from Schenectady International as SP-1045. The properties of these resins are given in Table 3. SP-1045 Resin is a heat reactive octylphenol-formaldehyde resin which contains methylol groups. It was specifically designed for the cure of isobutylene-isoprene (Butyl) rubber by the resin cure system. The octyl group makes SP-1045 Resin compatible with elastomers, and can yield cements offering a wide range of properties. In addition, the methylol groups can be used as functional sites for a variety of reactions.

TABLE 3
SPECIFICATIONS

| Property | Min. | Max. | Test Method |
|---|---|---|---|
| Melting Point, Capillary, (° F.) | 140 | 150 | T06M01.01 |
| Softening Point, B&R, (° C.) | 80 | 95 | T06M02.01 |
| Methylol Content, (%) | 8 | 11 | T17M01.02 |
| Color, Gardner, 64% in Toluene | 1 | 6 | T04M01.03 |

Other phenolic resins useful in the polymeric blend include the novalac resins. Novolac resins are described in the Encyclopedia of Polymer Science and Engineering, Volume 11, pages 45-95 (1985).

The maleic anhydride-olefinic copolymers of the polymeric blend are available as EXXELOR-VA1803 from Exxon Mobil Co. Exxelor Va. 1803 is a high flow, amorphous ethylene copolymer functionalized with maleic anhydride by reactive extrusion. Its fully saturated backbone results in outstanding thermal and oxidative stability leading to enhanced weatherability. Moreover, its amorphous nature exhibits impact resistance at very low temperatures in blends with other polymers. Properties of EXXELOR-VA 1803 are shown in Table 4.

TABLE 4

| | Exxon Mobile Test | | Exxelor |
|---|---|---|---|
| Property | Method (based on) | Unit | VA 1803 |
| Maleic anhydride | FTIR EPK-04 QT-02 | | High (*) |
| Graft level | | | |
| Melt flow rate | ASTM D 1238 | g/10 min | 3 |
| (2.16 kg/230° C.) | | | |
| Melt flow rate (10 kg/ | ASTM D 1238 | g/10 min | 22 |
| 230° C.) | | | |
| Density | DIN 53479 | g/cm3 | 0.66 |
| Glass transition | D8C | ° C. | −57 |
| temperature (Tg) | | | |
| Volatiles | AM-S 350.03 | % | 0.15 max. |
| Color | ASTM E 313-96 | Yellowness | 25 max |
| | | Index Pellet | |

(*) MA level is typically in the range of 0.5 to 1.0 wt %
The values indicated in the table describe typical properties but do not constitute specification limits.

The ethylene-vinyl acetate copolymers (EVA) of the polymeric blend have a vinyl acetate percentage by weight relative to the ethylene in the range of 15-40 percent by weight. The term “ethylene-vinyl acetate copolymer” includes both the dipolymers and the terpolymers of ethylene with vinyl acetate and with carbon monoxide. Most commercial EVA dipolymers contain about 2-55 percent by weight of vinyl acetate. Terpolymers of ethylene with vinyl acetate and with carbon monoxide may contain about 18-40 percent by weight of vinyl acetate and 2-12 percent by weight of carbon monoxide. Polymers of ethylene with vinyl acetate are available from the E.I. DuPont de Nemours and Company, under the trademark Elvax®.

In preparing hoses, tubing or slip-resistant articles in accordance with this invention, the polymeric blends can be coextruded as layers directly in contact with one another, so that the resultant adhesion between the two layers occurs without need for a tie layer, i.e., the coextrusion is carried out in the absence of a tie layer. When the coextruded laminate is in the form of tubing, the thickness of the layer can range, for example, from 4 to 24 mils e.g. with the conventional thickness being about 8 to 12 mils.

The following are specific examples illustrating the composition and method of preparing the polymeric blends of this invention.

### EXAMPLE 1

| | Parts by Weight |
|---|---|
| Polyether-based thermoplastic polyurethane (TPU) | 50 |
| Styrene-isoprene styrene block copolymer | 45 |
| Phenolic resin (SP 1045) | 0.5 |
| Color master batch | 4.5 |

### EXAMPLE 2

| | Parts by |
|---|---|
| | Weight |
| Polyether-based thermoplastic polyurethane | 50 |
| Styrene-isoprene-styrene block copolymer (Vector 4111) | 25 |
| Ethylene-vinyl acetate copolymer (EVA) | 20 |
| Phenolic resin | 0.5 |
| Color master batch | 4.5 |

### EXAMPLE 3

| | Parts by |
|---|---|
| | Weight |
| Polyvinyl chloride | 40 |
| Styrene-isoprene styrene block copolymer (Vector 4111) | 50 |
| Maleic anhydride ethylene copolymer (VA 1803) | 9.0 |
| Phenolic resin (SP 1045) | 1.0 |

### EXAMPLE 4

| | Parts by |
|---|---|
| | Weight |
| Polyether-based thermoplastic polyurethane | 50 |
| Styrene-isoprene-styrene block copolymer (Vector 4111) | 25 |
| Ethylene-vinyl acetate copolymer (EVA) | 20 |
| Maleic anhydride-ethylene copolymer (VA 1803) | 4.5 |
| Phenolic resin (SP 1045) | 0.5 |

### EXAMPLE5

| | Parts by |
|---|---|
| | Weight |
| Polyvinyl chloride homopolymer (oxyvinyl 190F) | 40 |
| Styrene-isoprene-styrene block copolymer (Vector 4111) | 50 |
| Maleic anhydride-ethylene copolymer (VA 1803) | 9.0 |
| Phenolic resin (SP 1045) | 1.0 |

The polymeric blend of Example 3 was bonded onto flexible polyvinyl chloride substrate and tested as follows (Table 5). The coefficient of friction (ASTM D-1894-05) was determined using a MTS 5/G Series tester. A swatch of the material was mounted to a wooden sled loaded with 5 lbs. wts. and pulled across a dry glass substrate at 0.5 ft. per minute. The puncture resistance was tested at 12.0 ipm per modified ASTM D-751. (Modification: the specimen is punctured while laying perpendicular to the piercing instrument as opposed to sitting at a 45° angle).

TABLE 5
Roofing Slip-Resistant Membrane of Example 3

| | |
|---|---|
| STATIC | KINETIC |

Coefficient of Friction

| | | |
|---|---|---|
| DRY | | |
| Average | 0.845 | 1.014 |
| Standard Deviation | 0.169 | 0.113 |
| WET | | |
| Average | 0.88 | 0.922 |
| Standard Deviation | 0.093 | 0.057 |

Puncture Resistance

| | |
|---|---|
| Average | LBS/Force |
| | 16 |

TABLE 6

| | | Tear | | | |
|---|---|---|---|---|---|
| Identification | | Resistance Die | Tensile | | 100% |
| of Polymeric | Shore A | @ (lbs/inch | Strength | Elongation | Elongation |
| Blend | Hardness | with) | (PSI) | Break (%) | (PSI) |
| Ultra-violet | 52, 52, 58, 50 | 125 | 289 | 267 | 261 |
| Fire proof of | 53 | 145 | 272 | 72 | — |
| Roofing | | 161 | 363 | 356 | 319 |
| membrane | | 154 | 370 | 420 | 322 |
| | | 135 | 376 | | 318 |
| Roof-Walkway | 52, 59, 54, 55 | 127 | 2210 | 551 | 502 |
| Polyvinyl | 57 | 130 | 2066 | 522 | 495 |
| chloride | | 134 | 2090 | 550 | 419 |
| Substrate | | 140 | 2480 | 550 | 448 |
| | | 135 | 2523 | 573 | 512 |
| | | 133 | | | |

The tear and tensile test data in Table 6 were performed at a crossbead rate of twenty (20) inches per minute at room temperature.

In preparing the polymeric blends bonded to a substrate, e.g. extruded or molded, there are specific substrated that can be used depending on the end use of the article. For example, when preparing a slip-resistant walkway, the polymeric blend is preferably bonded, e.g. extruded onto an ABS resin, polyethylene, polypropylene, polyvinyl chloride, or PVC-nitrile-butadiene copolymer substrate. In preparing hoses or tubing for use in fuel systems, the preferred substrates also include the polyamides, polypropylene, polyethylene, polyvinyl chloride, or a nitrile-butadiene-PVC rubber as the inside wall of the tube.

The copolymers of acrylonitrile-butadiene blended with polyvinyl chloride can be obtained from Precision Polymer Engineering of the United Kingdom under the designation NBR/PVC. These PVC-nitrile-butadiene copolymers have excellent resistance to petroleum, and mineral based fuels and oils as shown by the properties in Table 7.

TABLE 7
TYPICAL PHYSICAL PROPERTIES:

| | Unit | Test Method | Value |
|---|---|---|---|
| Property | | | |
| Hardness (points) | °IRHD | ASTM D 1415 (=ISO 48) | 65 |
| Tensile strength | MPa | ASTM D 395 (=ISO 37) | 10.0 |
| Elongation at break | % | ASTM D 412 (=ISO 37) | 300 |
| Compression Set, | | | |
| Method B; | | | |
| 24 hours at 100° C. | % | ASTM D 395 (=ISO 815) | 50 |
| (212° F.) | | | |
| Heat Resistance; | | | |
| 70 hours at 100° C. | | ASTM D 573 (=ISO 188) | |
| (158° F.) | | | |
| Hardness change (points) | °IRHD | ASTM D 1415 (=ISO 48) | ±15 |
| Tensile strength change | % | ASTM D 412 (=ISO 37) | ±30 |
| Elongation at break | % | ASTM D 412 (=ISO 37) | −50 |
| change | | | |
| Low temperature | | | |
| resistance; | | | |
| Non-brittle after 3 | ° C. | | −40 |
| minutes at | | | |

When preparing a foamed product of an acrylonitrile-butadiene-polyvinyl chloride copolymer bonded to the polymeric blends of this invention, the foaming or blowing agents are known as HYDROCEROL®, a trademark of Clariant. Clariant Chemical Blowing Agents decompose at processing temperatures and form various gases that expand thermoplastics, resulting in a fine cellular structure. The standard range of chemical blowing agents and nucleating agents in masterbatch and powder form allow precise metering of a wide range of active ingredients for direct gassing for the foaming of thermoplastic resins (PE, PP, PA, PS, ABS, PET, PVC, PC, PPO, PPE, TPE, TPO, TPU, TPR, EVA blends. Foaming of thermoplastic resins offers the following advantages: weight reduction, raw material savings, thermal and acoustic insulation, elimination of warpage and sink marks, increase in wall stiffness and surface textures. HYDROCEROL chemical blowing agents are suitable for standard injection molding, structural foam mounding, gas counter pressure, expanded mold process and sandwich molding.

Suitable polyamides used as the substrate with the polymeric blends of the present invention include the various polyamides (nylons preferable nylon 6 of 12) available from E.I. du Pont de Nemours under different Trademarks e.g. ELVAMIDE. The invention provides improved tubing or hose for fluid transport comprised of polyamides, e.g. nylons in the form of monolayer tubing for conveying fuel. These polyamides are well-known in the art; see, for example, Kirk-Othmer, Encyclopedia of Chemical Technology, 4^{th} ed., Vol. 19. The ABS resins are known as acrylonitrite-butadiene-styrene thermoplastic resins which can be obtained from GE Plastics under the trademark CYCOLAC. The three monomer system (A, B, S) allows the tailoring of the properties of the resins. Techniques and methods for coextruding and bonding multilayer construction of polymers, i.e. polymeric laminates are well known in the art and need not be further disclosed herein.

Modification of this invention will occur to one skilled in the art, and such modifications are deemed to be within the scope of the invention as set forth in the appended claims.

1. An article having ultra-violet stability and a high coefficient of friction derived from a polymeric blend comprising from about 30 to 60 parts by weight of a polymer selected from the group consisting of thermoplastic polyurethane and polyvinyl chloride, 20 to 60 parts by weight of a styrene-isoprene block copolymer, 0 to 2.0 parts by weight of a phenolic resin, 0 to 5.0 parts by weight of a color reagent, 0 to 20 parts by weight of a maleic anhydride-ethylene copolymer, and 0 to 30 parts by weight of an ethylene-vinyl acetate copolymer.

2. The article of claim 1 wherein the polymer in the polymeric blend is a thermoplastic polyurethane.

3. The article of claim 1 wherein the polymer in the polymeric blend is polyvinyl chloride.

4. The article of claim 1 wherein the polymeric blend is bonded to a flexible substrate.

5. The article of claim 4 wherein the flexible substrate is polyvinyl chloride.

6. The article of claim 4 wherein the flexible substrate is polypropylene.

7. The article of claim 4 wherein the flexible substrate is polyamide.

8. The article of claim 4 wherein the polymeric blend comprises the ethylene-vinyl acetate copolymer in an amount ranging from about 15 to 25 parts by weight.

9. The article of claim 4 wherein the polymeric blend comprises the maleic anhydride-ethylene copolymer in an amount ranging from about 1.0 to 15 parts by weight.

10. The article of claim 5 wherein the polymeric blend comprises the ethylene-vinyl acetate copolymer in an amount ranging from about 15 to 25 parts by weight and the maleic anhydride-ethylene copolymer in an amount ranging from about 5.0 to 10 parts by weight.

11. The article of claim 3 wherein the polymeric blend comprises the maleic anhydride-ethylene copolymer in an amount ranging from about 1.0 to 15 parts by weight.

12. The article of claim 4 wherein the thermoplastic polyurethane is a polyether-based thermoplastic polyurethane.

13. The article of claim 8 wherein the flexible substrate is synthetic fabric.

14. A process for preparing an article having ultraviolet stability and a high coefficient of friction which comprises bonding a polymeric blend onto a flexible substrate; said polymeric blend comprising from about 30 to 60 parts by weight of a polymer selected from the group consisting of thermoplastic polyurethane and polyvinyl chloride, 20 to 60 parts by weight of a styrene-isoprene block copolymer, 0 to 2.0 parts by weight of a phenolic resin, 0 to 5.0 parts by weight of a color reagent, 0 to 20 parts by weight of a maleic anhydride-ethylene copolymer, and 0 to 30 parts by weight of an ethylene-vinyl acetate copolymer.

15. The process of claim 14 wherein the flexible substrate is polyvinyl chloride.

16. The process of claim 14 wherein the flexible substrate is polypropylene.

17. The process of claim 14 wherein the flexible substrate is a synthetic fabric.

18. The process of claim 14 wherein the flexible substrate is polyamide.

19. The process of claim 14 wherein the polymeric blend is extruded onto the flexible substrated.

20. The process of claim 14 wherein the polymer in the polymeric blend is a thermoplastic polyurethane.

21. The process of claim 14 wherein the polymer in the polymeric blend is polyvinyl chloride.

22. The process of claim 14 wherein the polymeric blend comprises the styrene-isoprene block copolymer in an amount ranging from about 40 to 60 parts by weight.

23. The process of claim 14 wherein the polymeric blend comprises the thermoplastic polyurethane in an amount ranging from about 40 to 50 parts by weight.

24. The process of claim 14 wherein the polymeric blend comprises the maleic anhydride-ethylene copolymer in an amount ranging from about 1.0 to 15 parts by weight.

25. An article obtained by the process of claim 14.
